(19) United States
(12) Patent Application Publication
(10) Pub. No.: US 2026/0001031 A1
(43) Pub. Date: Jan. 1, 2026

(54) ULTRASONIC DEGASIFICATION FOR CARBON CAPTURE SOLVENTS

(71) Applicant: NUOVO PIGNONE TECNOLOGIE - S.R.L., Florence (IT)

(72) Inventors: Robert KRUMM, Oklahoma City, OK (US); Estanislado BRAVO, Oklahoma City, OK (US)

(21) Appl. No.: 18/880,778

(22) PCT Filed: Jul. 6, 2023
(86) PCT No.: PCT/EP2023/025314

§ 371 Date: Jan. 2, 2025

Related U.S. Application Data
(60) Provisional application No. 63/359,093, filed on Jul. 7, 2022.

(51) Int. Cl. B01D 53/14

(52) U.S. Cl. CPC B01D 53/1475; B01D 2257/504; B01D 2258/0283; B01D 2259/816

(57) ABSTRACT

A post-combustion carbon capture system is configured to remove carbon dioxide from a post-combustion feed stream. The post-combustion carbon capture system includes an absorption tower that is configured to produce clean gas with a reduced carbon dioxide concentration and loaded solvent from the post-combustion feed stream. The post-combustion carbon capture system further includes a stripper tower downstream from the absorption tower, and an ultrasonic degasification module configured to remove oxygen from the loaded solvent. In another embodiment, the ultrasonic degasification module is incorporated into a biogas processing system and configured to remove oxygen from a carbon dioxide-loaded solvent.

### RELATED APPLICATIONS

This application claims the benefit of U.S. Provisional Patent Application Ser. No. 63/359,093 filed Jul. 7, 2022 entitled “Ultrasonic Degasification Unit for Carbon Capture Solvents,” the disclosure of which is herein incorporated by reference.

### FIELD OF THE INVENTION

This invention relates generally to carbon capture systems, and more particularly, but not by way of limitation, to an improved system for preserving solvents or absorbents used in carbon capture applications.

### BACKGROUND

Carbon dioxide is the primary greenhouse gas emitted by human activities. In 2020, carbon dioxide accounted for about 79% of all human-based greenhouse gas emissions in the United States. Although there are a variety of carbon dioxide mitigation techniques, the use of liquid solvents and absorbents has been widely adopted. Amine-based solvents like monoethanolamine (MEA) have been found to be particularly effective at capturing carbon dioxide.

Nonetheless, MEA and other amine-based solvents tend to degrade under elevated temperatures and in the presence oxygen, which can limit their usefulness and increase the expense associated with these carbon capture technologies. For large scale carbon capture projects, amine solvent degradation can cost hundreds of millions of dollars. Most of the amine degradation occurs in the regenerator where the solvent is heated to liberate carbon dioxide from the solvent. Air dissolved in the carbon capture solvent accelerates the degradation of the solvent.

The oxygen content in the produced carbon dioxide stream is a tightly controlled parameter. Preferred ranges are often below 10 ppm (mmol/mol) of oxygen. Dissolved air in the carbon capture solvent can contaminate the carbon dioxide stream with oxygen at around 300 ppm (mmol/mol). Current methods for removing oxygen include catalytic oxidation or cryogenic distillation. The current practice is to design carbon capture absorption towers with holdup volumes and residence times that are large enough to facilitate deaeration of the solvent. Structured packing or agitation can be used to accelerate the coalescence of air bubbles.

Although these measures have enjoyed some success, oversizing the absorption towers increases many costs associated with amine-based carbon capture projects. Accordingly, there is a need for an improved process for removing oxygen from amine-based carbon capture solvents that overcomes the deficiencies of the prior art.

### SUMMARY OF THE INVENTION

In one aspect, the present disclosure is directed to a post-combustion carbon capture system configured to remove carbon dioxide from a post-combustion feed stream. The post-combustion carbon capture system includes an absorption tower that is configured to produce clean gas with a reduced carbon dioxide concentration and loaded solvent from the post-combustion feed stream. The post-combustion carbon capture system further includes a stripper tower downstream from the absorption tower, and an ultrasonic degasification module configured to remove oxygen from the loaded solvent.

In another aspect, the present disclosure is directed to a gas processing system configured to remove carbon dioxide from a biogas feed stream. The biogas processing system includes a contactor column and a stripper column. The contactor column is configured to produce “sweetened” gas and loaded solvent from the biogas feed stream. The stripper column is downstream from the contactor column and configured to receive the loaded solvent. The biogas processing system also includes an ultrasonic degasification probe that is configured to remove oxygen from a loaded solvent.

In yet another aspect, embodiments of the present invention include a method for removing carbon dioxide from a feed stream that includes carbon dioxide. The method includes the steps of contacting the feed stream with a carbon capture solvent to produce loaded carbon capture solvent, and degassing the loaded carbon capture solvent stream with an ultrasonic degasification probe to remove oxygen from the loaded carbon capture solvent stream to produce a degassed stream of carbon capture solvent.

### BRIEF DESCRIPTION OF THE DRAWINGS

FIG. 1 is a flow diagram for a carbon capture process for removing carbon dioxide from a post-combustion gas feed stream.

FIG. 2 is a flow diagram for a carbon capture process for removing carbon dioxide from a biogas feed stream.

### WRITTEN DESCRIPTION

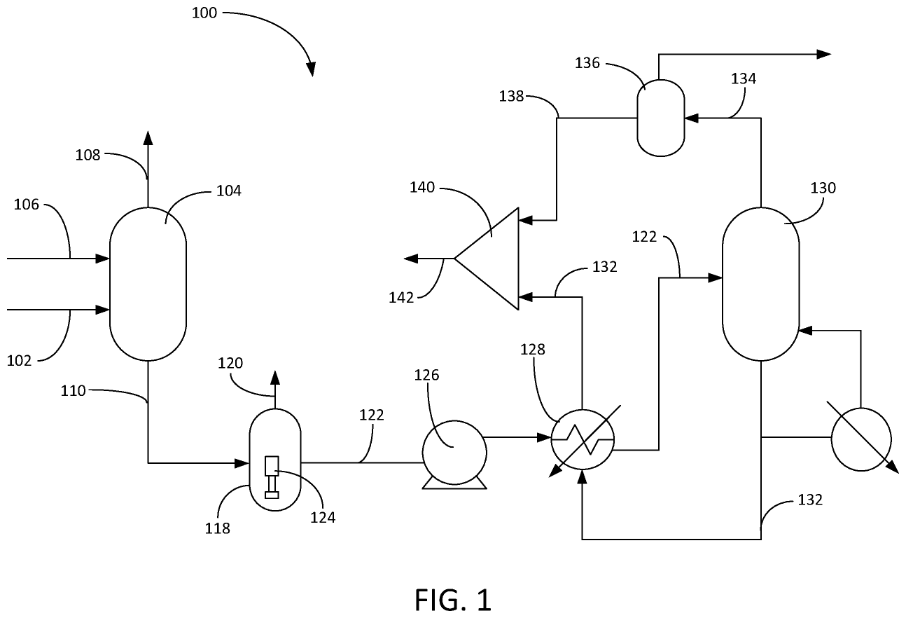

FIG. 1 is a process flow diagram for a carbon capture system 100 that is designed to remove carbon dioxide (CO₂) from a post-combustion feed stream 102. The feed stream 102 is typically a flue gas stream that is carried to an absorption tower 104, where it mixes with a solvent injected from a solvent stream 106. Clean gas with a reduced concentration of CO₂ is discharged in a gas discharge stream 108.

In some embodiments, the solvent is an amine-based solvent. Suitable solvents include mixtures of water with monoethanolamine (MEA), diethanolamine (DEA), triethanolamine (TEA) or potash. Within this disclosure, the terms solvent, carbon capture solvent, absorbent, and carbon capture absorbent are used interchangeably. The loaded solvent is discharged from the absorption tower 104 through an absorbent discharge stream 110. The absorbent discharge stream 110 is fed into a degasification module 118.

The degasification module 118 is configured to separate oxygen from the absorbent discharge stream 110. The separated oxygen is discharged through an oxygen removal stream 120, and the remaining solvent mixture is removed from the degasification module through a degassed stream 122. In exemplary embodiments, the degasification module 118 includes an ultrasonic degasification probe 124. The ultrasonic degasification probe 124 is configured to vibrate at one or more selected frequencies that facilitate and encourage the formation and coalescence of oxygen bubbles from the absorbent discharge stream 110.

Ultrasonic degasification probes 124 are available from a number of commercial sources, including the Hielscher company. For a pilot plant with a design throughput of about 20 tons per day (TPD) and an estimated carbon capture solvent flow of about 350 liters per minute (LPM), a properly sized degasification module 118 can include three Hielscher UIP4000 ultrasonic processor units connected in a parallel flow configuration. The number and capacity of the degasification probes 124 within the degasification module 118 is scalable to accommodate carbon capture systems 100 covering a wide range of throughputs and operating parameters.

The degassed “rich” stream 122 is directed through a pump 126 to a heat exchanger 128, where it is pre-heated before entering a stripper tower 130 as a rich, hot stream. The stripper tower 130 heats the loaded solvent to release the carbon dioxide from the solvent. The stripped “lean” solvent is carried out of the bottom of the stripper tower 130 in a lean liquid stream 132 to the heat exchanger 128, where it transfers heat to the incoming rich stream 122.

The released carbon dioxide gas is carried in a hot gas stream 134 out of the top of the stripper tower 130 to a condenser 136. The condenser 136 produces a condensed solvent stream 138 that is fed to a recovered solvent mixer 140, where it is combined with the lean liquid stream 132 to form a recycled solvent stream 142. The recycled solvent stream 142 can be directed to the primary solvent stream 106 for use within the absorption tower 104. The remaining carbon dioxide gas is removed from the condenser 136 for downstream processing or disposal.

Thus, the incorporation of the ultrasonic degasification module 118 within the post-combustion carbon capture system 100 extends the lifespan of the carbon capture solvent by removing oxygen that would otherwise cause oxidative degradation. Although the degasification module 118 is depicted in FIG. 1 as an independent unit, it will be appreciated that in other embodiments the degasification module 118 can be included inside the absorption tower 104. In yet other embodiments, the degasification module 118 can be connected between the pump 126 and the heat exchanger 128. In other embodiments the degasification module 118 can be placed between the heat exchanger 128 and stripper tower 130.

In some applications, it may be desirable to incorporate multiple ultrasonic degasification modules 118 within the post-combustion carbon capture system 100. For example, a first degasification module 118 can be placed within the absorption tower 104 and a second degasification module 118 can be placed between the absorption tower 104 and the stripper tower 130 to advantageously remove oxygen from the solvent. In each case, passing the loaded solvent through the degasification module 118 removes a significant fraction of the dissolved oxygen. Ultrasonication removes suspended bubbles to reduce the level of dissolved oxygen in the amine-based solvent, which reduces the oxidative degeneration of the amine-based solvent.

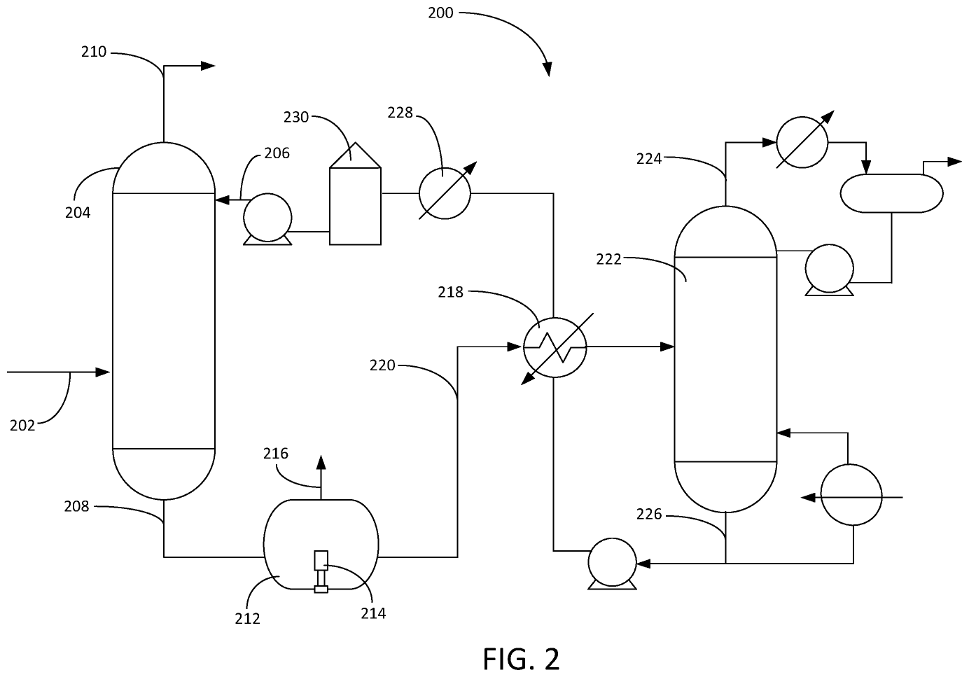

Turning to FIG. 2, shown therein is a biogas processing system 200. The term “biogas” generally refers to a mixture of gases, consisting primarily of methane, carbon dioxide and hydrogen sulfide. As used in this disclosure, the term “biogas” refers to any gas produced from agricultural waste, cattle operations, municipal waste (e.g., landfill gas), plant material, sewage, green waste and food waste. The biogas processing system 200 is generally configured to remove a portion of the carbon dioxide from a biogas feed stream 202 through use of a suitable solvent in a contactor column 204. The biogas feed stream 202 can originate from an open source (e.g., feedlots) or a closed source (e.g., anaerobic digester systems).

As illustrated in FIG. 2, the biogas feed stream 202 enters a lower portion of the contactor column 204. A carbon capture solvent is injected through a solvent injection stream 206 into an upper portion of the contactor column 204. In some embodiments, the solvent is an amine-based solvent such as monoethanolamine (MEA), diethanolamine (DEA), triethanolamine (TEA), or potash. The solvent mixes with the biogas in the contactor column 204, where it absorbs carbon dioxide and other impurities. The loaded solvent is discharged through a loaded solvent stream 208 while the “sweetened” gas is discharged through a sweet gas stream 210 for further processing or sale.

The loaded solvent stream 208 can be directed to a flash vessel 212, where the rapid decrease in pressure encourages the separation of liquid and gaseous components. In exemplary embodiments, the flash vessel 212 includes an ultrasonic degasification probe 214 that further encourages the separation of dissolved gases from the liquid fraction of the loaded solvent stream 208. The released gases are discharged through an off gas stream 216 while the rich loaded solvent is passed to a heat exchanger 218 through a rich solvent stream 220.

The heat exchanger 218 increases the temperature of the rich solvent stream 220 before it is injected into a stripper column 222. The stripper column 222 increases the temperature of the loaded solvent to release the absorbed carbon dioxide and other impurities (e.g., hydrogen sulfide). The separated carbon dioxide is discharged through a gas outlet 224 on the top of the stripper column 222, while the solvent is discharged through a lean solvent stream 226 on the bottom of the stripper column 222. The carbon dioxide (or “acid gas”) can be directed to further downstream processing equipment.

The solvent in the lean solvent stream 226 is passed through the heat exchanger 218, where it transfers heat to the incoming rich solvent stream 220. The lean solvent stream 226 can be passed through a cooler 228 before reaching a solvent tank 230. From the solvent tank 230, the lean solvent can be reinjected into the contactor column 204 through the injection stream 206.

In this way, the biogas processing system 200 incorporates an ultrasonic degasification probe 214 to remove dissolved oxygen from the loaded solvent stream 208. This extends the useful life of the carbon capture solvent. Although the biogas processing system 200 has been described as having the ultrasonic degasification probe 214 located inside the flash vessel 214 between the contractor column 204 and the stripper column 222, in other embodiments, the ultrasonic degasification probe 214 is incorporated into a separate ultrasonic degasification module 232. The independent ultrasonic degasification module 232 can be located upstream or downstream from the flash vessel 212, or elsewhere in the biogas processing system 200. In some applications, it may be desirable to incorporate multiple ultrasonic degasification probes 214 or ultrasonic degasification modules 232 within the biogas processing system 200. For example, a first degasification module 232 can be placed upstream from the flash vessel 212 and a second degasification module 232 can be placed downstream from the flash vessel 212.

It is to be understood that even though numerous characteristics and advantages of various embodiments of the present invention have been set forth in the foregoing description, together with details of the structure and functions of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. It will be appreciated by those skilled in the art that the teachings of the present invention can be applied to other systems without departing from the scope and spirit of the present invention.

What is claimed is:

1. A post-combustion carbon capture system configured to remove carbon dioxide from a post-combustion feed stream, the post-combustion carbon capture system comprising:
an absorption tower, wherein the absorption tower is configured to produce clean gas with a reduced carbon dioxide concentration and loaded solvent from the post-combustion feed stream;
a stripper tower downstream from the absorption tower; and
an ultrasonic degasification module configured to remove oxygen from the loaded solvent.

2. The post-combustion carbon capture system of claim 1, wherein the ultrasonic degasification module includes an ultrasonic degasification probe.

3. The post-combustion carbon capture system of claim 2, wherein the ultrasonic degasification probe is located inside the absorption tower.

4. The post-combustion carbon capture system of claim 2, wherein the ultrasonic degasification module is located between the absorption tower and the stripper tower.

5. The post-combustion carbon capture system of claim 1, wherein the post-combustion carbon capture system comprises a plurality of ultrasonic degasification modules.

6. A biogas processing system configured to remove carbon dioxide from a biogas feed stream, the biogas processing system comprising:
a contactor column, wherein the contactor column is configured to produce sweetened gas and loaded solvent from the biogas feed stream;
a stripper column downstream from the contactor column, wherein the stripper column receives the loaded solvent; and
an ultrasonic degasification probe configured to remove oxygen from loaded solvent.

7. The biogas processing system of claim 6, further comprising a flash vessel and wherein the ultrasonic degasification probe is incorporated inside the flash vessel.

8. The biogas processing system of claim 6, wherein the ultrasonic degasification probe is incorporated into an independent ultrasonic degasification module.

9. The biogas processing system of claim 8, wherein the biogas processing system comprises a plurality of ultrasonic degasification modules.

10. A method for removing carbon dioxide from a feed stream that includes carbon dioxide, the method comprising the steps of:
contacting the feed stream with a carbon capture solvent to produce loaded carbon capture solvent; and
degassing the loaded carbon capture solvent stream with an ultrasonic degasification probe to remove oxygen from the loaded carbon capture solvent stream to produce a degassed stream of carbon capture solvent.

11. The method of claim 10, wherein the feed stream is a post-combustion feed stream that includes carbon dioxide.

12. The method of claim 11, wherein the step of contacting the feed stream further comprises contacting the post-combustion feed stream with a carbon capture solvent further comprises contacting the post-combustion feed stream with the carbon capture solvent in an absorption tower.

13. The method of claim 10, wherein the feed stream is a biogas feed stream that includes carbon dioxide.

14. The method of claim 13, wherein the step of contacting the feed stream further comprises contacting the biogas feed stream with a carbon capture solvent further comprises contacting the biogas feed stream with the carbon capture solvent in a contactor column.

15. The method of claim 14, wherein the step of degassing the loaded carbon capture solvent stream further comprises passing the loaded carbon capture stream through a degasification module that includes the ultrasonic degasification probe.
